(19) United States
(12) Patent Application Publication
(10) Pub. No.: US 2008/0002771 A1
(43) Pub. Date: Jan. 3, 2008

(54) VIDEO SEGMENT MOTION CATEGORIZATION

(75) Inventor: George Qian Chen, Irving, TX (US)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/428,246

(22) Filed: Jun. 30, 2006

(51) Int. Cl. H04N 11/02; H04N 7/12

(52) U.S. Cl. 375/240.16; 375/240.26

(57) ABSTRACT

Analysis of video segments based upon the type of motion displayed in the video segments. A video segment is analyzed to determine if it displays a scene that is stationary or has motion. If a video segment displays a scene with motion, then the segment is further analyzed to determine if the motion resulted from camera movement, or if it resulted from movement of the object that was filmed. If the video segment displays a scene with motion created by camera movement, then the video segment is analyzed to determine if the movement was caused by controlled camera movement or unstable camera movement. These categories of video motion may then be used to determine the perceptual importance of the video segment. If the video segments are in a compressed data format, such as the MPEG-2 or MPEG-4 format, the motion displayed in the video segments can be categorized based upon motion vectors in the compressed data.

### FIELD OF THE INVENTION

The present invention relates to the analysis of video segments based upon the type of motion displayed in the video segments. More particularly, various examples of the invention relate to analyzing motion vectors encoded into a segment of a compressed video bitstream, and then classifying the video segment into a category that reflects its perceptual importance.

### BACKGROUND OF THE INVENTION

The use of video has become commonplace in modern society. New technology has provided almost every consumer with access to inexpensive digital video cameras. In addition to purpose-specific digital video cameras, other electronic products now incorporate digital cameras. For example, still-photograph cameras, personal digital assistants (PDAs) and mobile telephones, often will allow a user to create or view video. Besides allowing consumers to easily view or create video, new technology also has provided consumers with new opportunities to view video. For example, many people now view video footage of a news event over the Internet, rather than waiting to read a printed article about the news event in a newspaper or magazine.

In view of the large amount of video currently being created and viewed, various attempts have been made to provide techniques for analyzing video. In particular, various attempts have been made to categorize video segments based upon the motion displayed in those segments. Some techniques, for example, have employed affine models to determine differences between images in a video segment. This technique typically has been used on a per-frame basis to identify video segments with images that have been created by controlled camera motion, such as zoom, pan, tilt, rotation, and divergence (that is, where the camera is moving toward or away from the filmed object). These techniques are not very useful, however, in identifying video segments produced when the camera was unstable, or when the segment contains a scene with object motion.

Other techniques have attempted to detect object motion in a video segment without using the affine model. Thus, neural networks have been trained to recognize both camera motion and object motion, typically on a per-frame basis. Still other techniques have been used for uncompressed video. Some methods have analyzed the joint spatio-temporal image volume of a video segment based on a structure tensor histogram, for example, while other methods have attempted to detect shaking artefacts in a video segment by tracing the trajectory of a selected region and checking if it changes direction every frame. These techniques typically are computationally resource intensive, however, and may not be compatible with compressed video of the type in common use today.

### BRIEF SUMMARY OF THE INVENTION

Various aspects of the invention relate to the analysis of video segments based upon the type of motion they display. With various implementations of the invention, for example, a video segment is analyzed to determine if it displays a scene that is stationary or has motion. If the video segment displays a scene with motion, then the segment is further analyzed to determine if the motion resulted from camera movement, or if it resulted from movement of the object that was filmed. If the video segment displays a scene with motion created by camera movement, then the video segment is analyzed still further to determine if the movement was caused by controlled camera movement or unstable camera movement (that is, whether or not the camera was shaking when the video segment was filmed). These four categories of video motion may then be used to determine the perceptual importance of analyzed video segments.

For example, a video segment displaying a scene with little or no motion may be important for an understanding of a larger video sequence. Typically, however, a viewer need only see a small portion of such a segment to understand all of the information it is intended to convey. On the other hand, if a video segment was created by controlled camera movement, such as panning, tilting, zooming, rotation or forward or backward movement of the camera, a viewer may need to see the entire segment to understand the cameraman's intention. Similarly, if a video segment displays a scene showing the filmed object in motion, the viewer may need to see the entire segment to appreciate the significance of the motion. If, however, a video segment displaying motion was created when the camera was unstable, the images in the video segment may be so erratic as to be meaningless.

According to various examples of the invention, a video segment is analyzed by determining a position change of at least one image portion in one frame relative to a corresponding image portion in another frame. More particularly, multiple image portions will typically appear in successive frames of a video segment. If the video segment displays motion, however, then the positions of one or more of these image portions will change between successive frames. If a representative magnitude of these position changes is below a first threshold value, then the video segment is categorized as stationary. For video in a compressed digital data format, such as the MPEG-2 or MPEG-4 format defined by the Moving Pictures Expert Group (MPEG), motion vectors encoded in the video bitstream can be used to determine the representative magnitude of position changes of an image portion in the video segment.

If the determined position changes have a representative magnitude at or above the first threshold value, then differences between the image portions of the video segment between are determined. That is, discrepancies between corresponding image portions in successive frames are measured. If the determined differences for the frames have a representative discrepancy above a second threshold value, then the video segment is categorized as complex. One example of a complex video segment might be video of an audience in a football stadium. Even if a camera filming the audience were held perfectly still, the images of the video segment might change significantly from frame-to-frame due to movement by individuals in the audience. With various implementations of the invention, affine modeling may be used to determine the representative discrepancy of differences between corresponding image portions in successive video frames. Again, for video in a compressed digital data format that uses motion vectors encoded in the video bitstream, the motion vectors can be used to determine the representative discrepancy of differences between corresponding image portions in successive frames.

If the representative discrepancy for differences between corresponding image portion of successive frames is at or below the second threshold value, then motion changes between the images in substantially opposite directions are identified. If the determined motion direction changes occur at a representative frequency above a third threshold value, then the video segment is categorized as shaky. For example, if the movement in a video segment alternates between moving up and down very quickly, or between moving left and right very quickly, then the video segment was probably filmed while the camera was unstable. If, on the other hand the identified motion direction changes have a representative frequency at or below the third threshold value, then the video segment is categorized as a moving video segment. With a moving video segment, for example, where the motion between images does not reverse direction frequently, the images are more likely to have been created by controlled zooming, panning, tilting, rotation or divergence of the camera, than by uncontrolled, unstable movement of the camera.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of a mobile terminal, in accordance with various embodiments of the invention;

FIGS. 2A-2C illustrate a block diagram showing the organization of a video sequence into smaller components, in accordance with various embodiments of the invention;

FIG. 3 illustrates an analysis tool that may be used to analyze and categorize a video segment in accordance with various embodiments of the invention;

FIGS. 4A and 4B illustrate a flowchart showing illustrative steps for categorizing a relevant video segment, in accordance with various embodiments of the invention;

FIG. 5 illustrates a chart showing the determined frame position change magnitude and a corresponding affine model residual for each frame in a first video segment, in accordance with various embodiments of the invention;

FIG. 6 illustrates a chart showing the determined frame position change magnitude and a corresponding affine model residual for each frame in a second video segment, in accordance with various embodiments of the invention; and

FIG. 7 illustrates a chart showing a frequency of zero-crossings for a third video segment, in accordance with various embodiments of the invention.

### DETAILED DESCRIPTION OF THE INVENTION

### Overview

In the following description of the various embodiments, reference is made to the accompanying drawings, which form a part hereof, and in which are shown by way of illustration various embodiments in which the invention may be practiced. It is to be understood that other embodiments may be utilized, and that structural and functional modifications may be made without departing from the scope and spirit of the present invention.

### Operating Environment

Various examples of the invention may be implemented using electronic circuitry configured to perform one or more functions of embodiments of the invention. For example, some embodiments of the invention may be implemented by an application-specific integrated circuit (ASIC). Alternately, various examples of the invention may be implemented by a programmable computing device or computer executing firmware or software instructions. Still further, various examples of the invention may be implemented using a combination of purpose-specific electronic circuitry and firmware or software instructions executing on a programmable computing device.

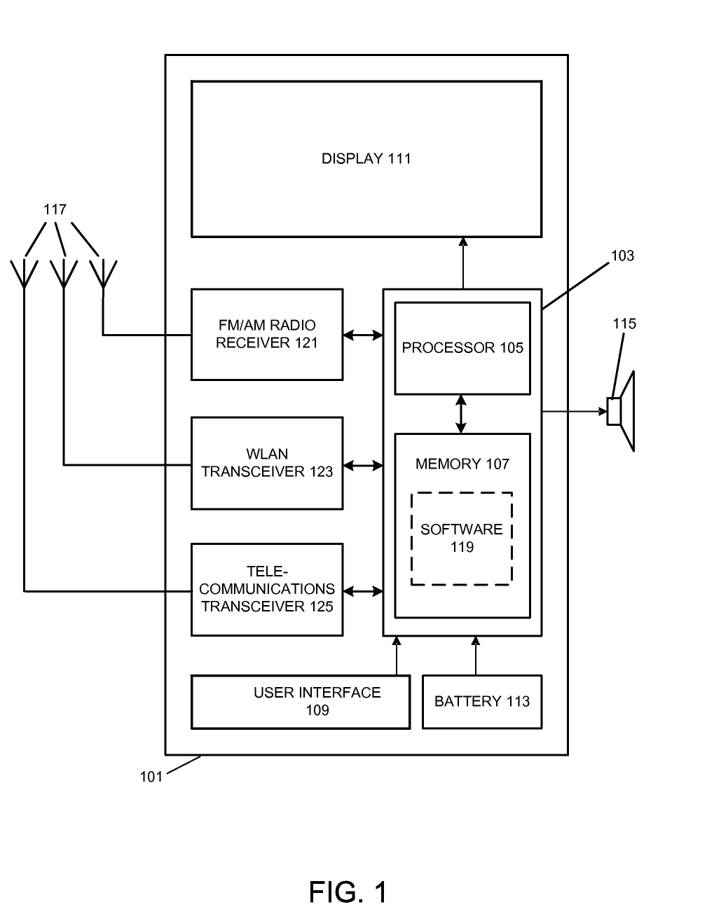

FIG. 1 illustrates an example of a mobile terminal 10 through which various embodiments may be implemented. As shown in this figure, the mobile terminal 101 may include a computing device 103 with a processor 105 and a memory 107. The computing device 103 is connected to a user interface 109, and a display 111. The mobile device 101 may also include a battery 113, a speaker 115, and antennas 117. The user interface 109 may itself include a keypad, a touch screen, a voice interface, one or more arrow keys, a joy-stick, a data glove, a mouse, a roller ball, a touch screen, or the like.

Computer executable instructions and data used by the processor 105 and other components within the mobile terminal 101 may be stored in the computer readable memory 107. The memory 107 may be implemented with any combination of read-only memory (ROM) or random access memory (RAM). With some examples of the mobile terminal 101, the memory 107 may optionally include both volatile and nonvolatile memory that is detachable. Software instructions 119 may be stored within the memory 107, to provide instructions to the processor 105 for enabling the mobile terminal 101 to perform various functions. Alternatively, some or all of the software instructions executed by the mobile terminal 101 computer may be embodied in hardware or firmware (not shown).

Additionally, the mobile device 101 may be configured to receive, decode and process transmissions through a FM/AM radio receiver 121, a wireless local area network (WLAN) transceiver 123, and/or a telecommunications transceiver 125. In one aspect of the invention, the mobile terminal 101 may receive radio data stream (RDS) messages. The mobile terminal 101 also may be equipped with other receivers/transceivers, such as, for example, one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal device may share parts or subassemblies with one or more other receivers in the mobile terminal device, or each receiver may be an independent subassembly.

It is to be understood that the mobile terminal 101 is only one example of a suitable environment for implementing various embodiments of the invention, and is not intended to suggest any limitation as to the scope of the present disclosure. As will be appreciated by those of ordinary skill in the art, the categorization of video segments according to various embodiments of the invention may be implemented in a number of other environments, such as desktop and laptop computers, multimedia player devices such as televisions, digital video recorders, DVD players, and the like, or in hardware environments, such as one or more an application-specific integrated circuits that may be embedded in a larger device.

### Compressed Video Format

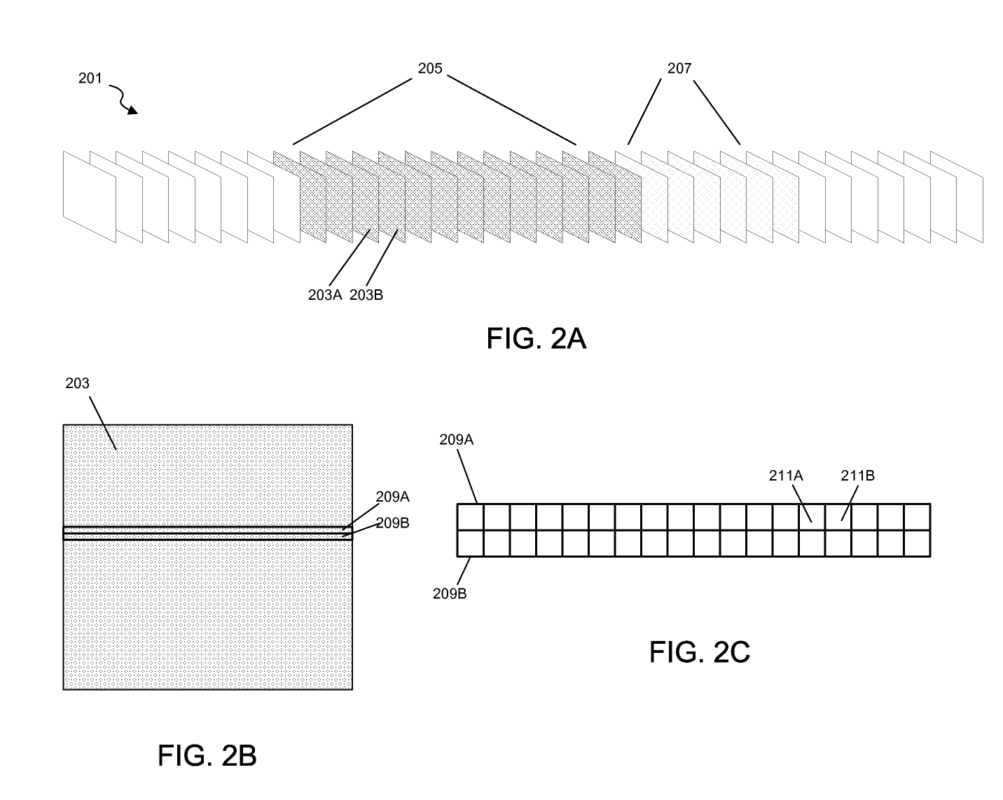

As will be discussed in more detail below, various implementations of the invention may be configured to analyze video segments that are encoded in a compressed format, such as the MPEG-2 or MPEG-4 format, which formats are incorporated entirely herein by reference. Accordingly, FIGS. 2A-2C illustrate an example of video data organized into the MPEG-2 format defined by the Motion Pictures Expert Group (MPEG). As seen in FIG. 2A, a video sequence 201 is made up of a plurality of sequential frames 203. Each frame, in turn, is made up of a plurality of picture element data values arranged to control the operation of a two-dimensional array of picture elements or “pixels”. Each picture element data value represents a color or luminance making up a small portion of an image (or, in the case of a black-and-white video, a shade of gray making up a small portion of an image). Full-motion video might typically require approximately 20 frames per second. Thus, a portion of a video sequence that is 15 seconds long may contain 300 or more different video frames.

The video sequence may be divided into different video segments, such as segments 205 and 207. A video segment may be defined according to any desired criteria. In some instances, a video sequence may be segmented solely accordingly to length. For example, with a video sequence filmed by a security camera continuously recording one location, it may be desirable to segment the video so that each video segment contains the same number of frames and thus requires the same amount of storage space. For other situations, however, such as with a video sequence making up a television program, the video sequence may have segments that differ in length of time, and thus in the number of frames. As will be appreciated from the following description, various aspects of the invention may be used to analyze a variety of video segments without respect to the individual length of each video segment.

With the MPEG-2 format, each video frame 203 is organized into slices, such as slices 209 shown in FIG. 2B. Each slice is in turn is organized from macroblocks, such the macroblocks 211 shown in FIG. 2C. According to the MPEG-2 format, each macroblock 211 contains lumina data for a 16×16 array of pixels (that is, for 4 blocks with each block being an 8×8 arrays of pixels). Each macroblock 211 may also contain chromatic information for an array of pixels, but the number of pixels corresponding to the chromatic information may vary depending upon the implementation. With the MPEG-2 format, the number of macroblocks 211 in a slice 209 may vary, but a slice will typically be defined as an entire row of macroblocks in the frame.

Each video frame is essentially a representation of an image captured at some instant in time. With some types of compressed data formats, a video sequence will include both video frames that are complete representations of the captured image and frames that are only partial representations of a captured image. Typically, unless a filmed object is moving very quickly, the captured images in sequential frames will be very similar. For example, if the video sequence is of a boat traveling along a river, the pixels displaying both the boat and the water will be very similar in each sequential frame. Further, the pixels displaying the background also will be very similar, but will move slightly relative to the boat pixels in each frame.

Accordingly, the video data for the images of the boat traveling down the river can be compressed by having an initial frame that describes the boat, the water, and the background, and having one or more of the subsequent frames describe only the differences between the captured image in the initial frame and the image captured in that subsequent frame. Thus, with these compression techniques, the video data also will include position change data that describes a change in position of corresponding image portions between images captured in different frames.

With video in the MPEG-2 format, for example, each frame may be one of three different types. The data making up an intra frame (an “I-frame”) is encoded without reference to any frame except itself (that is, the data in an I-frame includes a complete representation of the captured image). A predicted frame (a “P-frame”), however, includes data that refers to previous frames in the video sequence. More particularly, a P-frame includes position change data describing a change in position between image portions in the P-frame and corresponding image portions in the preceding I-frame or P-frame. Similarly, a bi-directionally predicted frame (a B-frame) includes data that refers to both previous frames and subsequent frames in the video sequence, such as data describing the position changes between image portions in the B-frame and corresponding image portions in the preceding and subsequent I-frames or P-frames.

With the MPEG-2 format, this position change information includes motion vector displacements. More particularly, P-frames and B-frames are created by a “motion estimation” technique. According to this technique, the data encoder that encodes the video data into the MPEG-2 format searches for similarities between the image in a P-frame and the image in the previous (and, in the case of B-frames, the image in the subsequent) I-frame or P-frame of the video sequence. For each macroblock in the frame, the data encoder searches for a reference image portion in the previous (or subsequent) I-frame that is the same size and is most similar to the macroblock. A motion vector is then calculated that describe the relationship between the current macroblock and the reference sample, and these motion vectors are encoded into the frame. If the motion vector does not precisely describe the relationship between the current macroblock and the reference sample, then the difference or “prediction error” also may encoded into the frame. With some implementations of the MPEG-2 format, if this difference or residual is very small, then the residual may be omitted from the frame. In this situation, the image portion represented by the macroblock is described by only the motion vector.

After the motion vectors and prediction errors are determined for the frames in the video sequence, each 8×8 pixel block in the sequence is transformed using an 8×8 discrete cosine transform to generate discrete cosine transform coefficients. These discrete cosine transform coefficients, which include a “direct current” value and a plurality of “alternating current” values, are then quantized, re-ordered and then run-length encoded.

### Analysis Tool

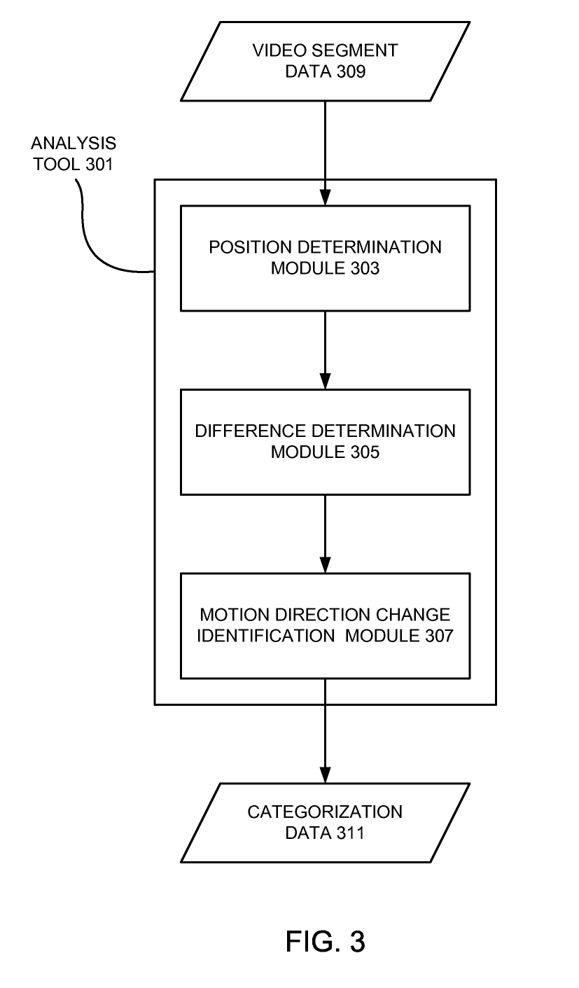

FIG. 3 illustrates an analysis tool 301 that may be used to analyze and categorize a video segment according to various implementations of the invention. As previously noted, each module of the analysis tool 301 may be implemented by a programmable computing device executing firmware or software instructions. Alternately, each module of the analysis tool 301 may be implemented by electronic circuitry configured to perform the function of that module. Still further, various examples of the analysis tool 301 may be implemented using a combination of firmware or software executed on a programmable computing device and purpose-configured electronic circuitry. Also, while the analysis tool 301 is described herein as a collection of specific modules, it should be appreciated that, with various examples of the invention, the functionality of the modules may be combined, further partitioned, or recombined as desired.

Referring now to FIG. 3, the analysis tool 301 includes a position determination module 303, a difference determination module 305, and a motion direction change identification module 307. As will be discussed in further detail below, the position determination module 303 analyzes image portions in each frame of a video segment, to determine the magnitude of the position change of each image portion between successive frames. If the position determination module 303 determines that the position changes of the image portions have a representative magnitude that falls below a first threshold value, then the position determination module 303 will categorize the video segment as a stationary video segment.

If the position determination module 303 does not categorize the video segment as a stationary video segment, then the difference determination module 305 will determine differences between the image portions in successive frames. More particularly, for each image portion in a frame, the difference determination module 305 will determine a discrepancy value between the image portion and a corresponding image portion in a successive frame. If the differences between image portions in successive frames of a video segment have a representative discrepancy that is above a second threshold value, then the difference determination module 305 will categorize the video segment as a complex video segment.

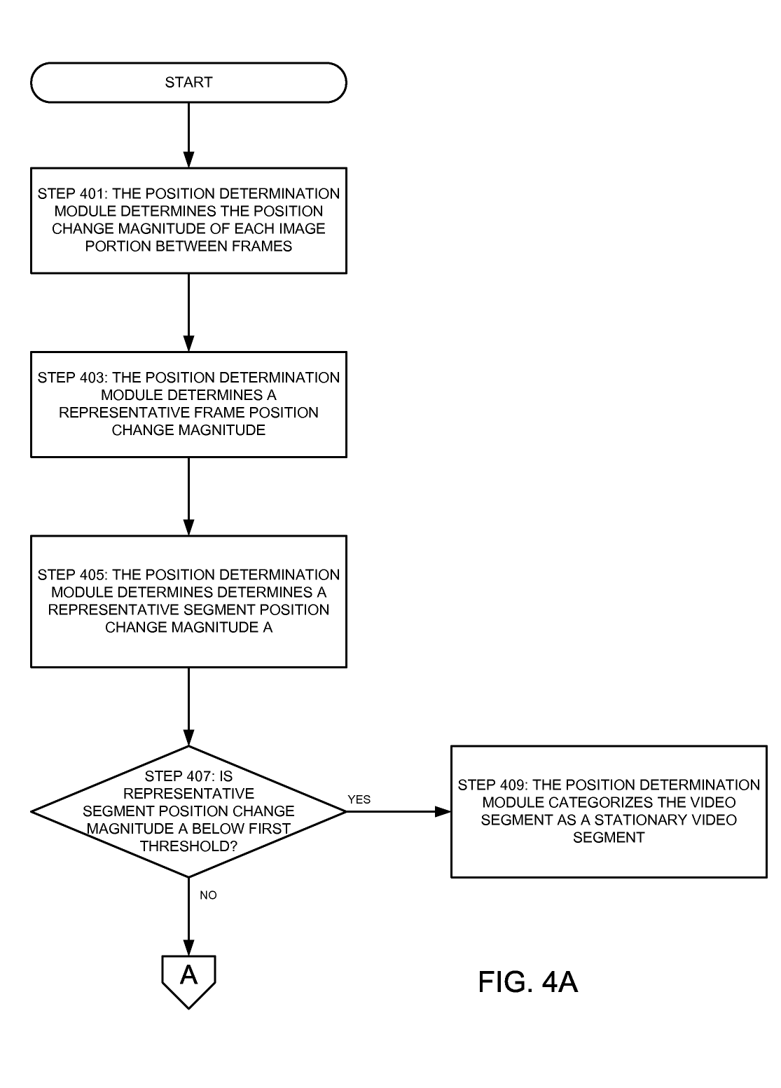

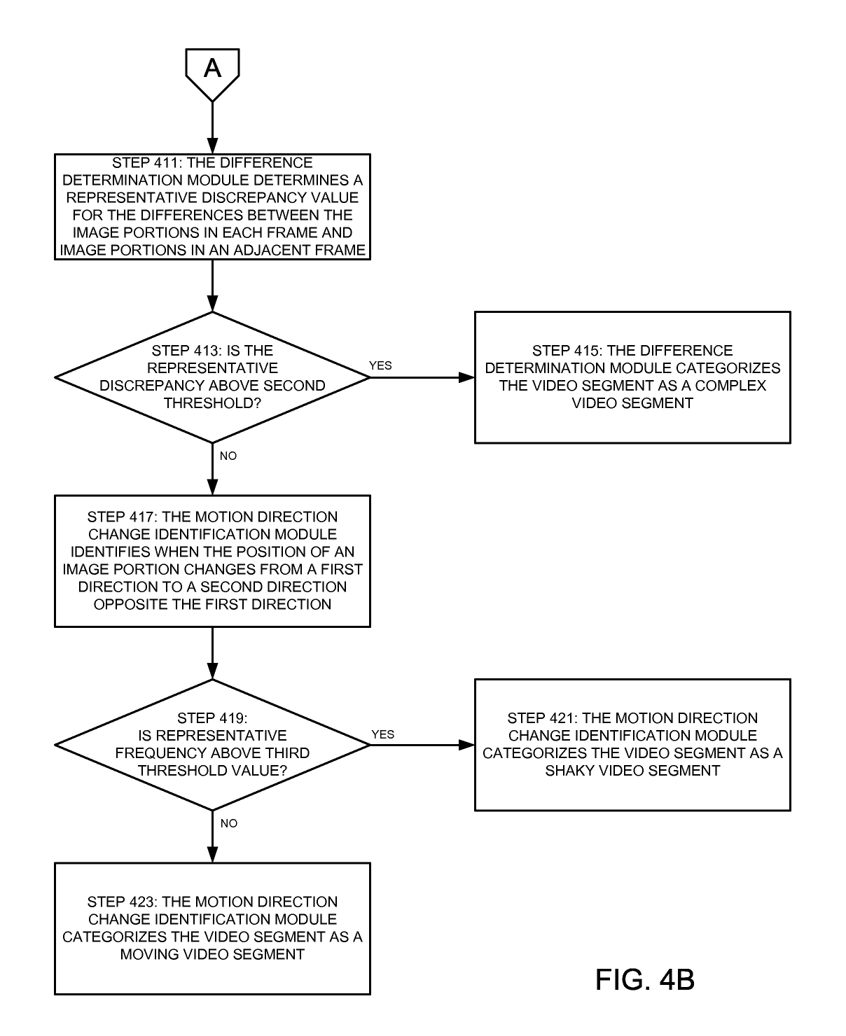

If the difference determination module 305 does not categorize the video segment as a complex video segment, then the motion direction change identification module 307 identifies instances in the video segment when the position of an image portion moves in a first direction, and then subsequently moves in a second direction substantially opposite the first direction. For example, the motion direction change identification module 307 may identify when the position of an image portion moves from left to right in a series of frames, and then moves from right to left in a subsequent series of frames. If the motion direction change identification module 307 determines that these motion direction changes occur at a representative frequency above a third threshold value, then the motion direction change identification module 307 will categorize the video segment as a shaky video segment. Otherwise, the motion direction change identification module 307 will categorize the video segment as a moving video segment. The operation of the tool 301 upon a video segment 309 will now be described in more detail with reference to the flowchart illustrated in FIGS. 4A and 4B

### The Position Determination Module

As previously noted, the analysis tool 301 analyzes image portions in frames of a video segment. With some examples of the invention, the analysis tool 301 may only analyze frames that include position change information. For example, with video encoded in the MPEG-2 or MPEG-4 format, the analysis tool 301 may analyze P-frames and B-frames. Thus, the analysis tool 301 will analyze the successive frames in a video segment that contain position change information. These types of frames will typically provide sufficient information to categorize a video segment without having to consider the information contained in the I-frames. It also should be appreciated that some video encoded in the MPEG-2 or MPEG-4 format may not employ B-frames. This type of simplified video data is more commonly used, for example, with handheld devices such as mobile telephones and personal digital assistants that process data at a relatively small bit rate. With this type of simplified video data, the analysis tool 301 may analyze only P-frames.

Turning now to FIG. 4A, in step 401, the position determination module 303 determines the magnitude of the position change of each image portion between successive frames in the segment. Next, in step 403, the position determination module 303 determines a representative frame position change magnitude that represents a change of position of corresponding image portions between frames. In this manner, the position determination module 303 can ascertain whether a series of video frames has captured a scene without motion (i.e., where the positions the image portions do not significantly change from frame to frame).

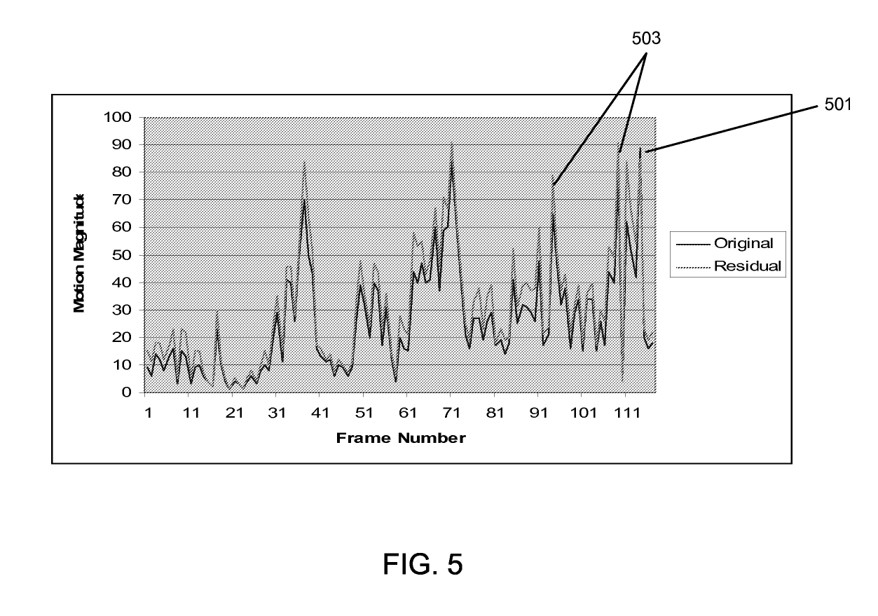

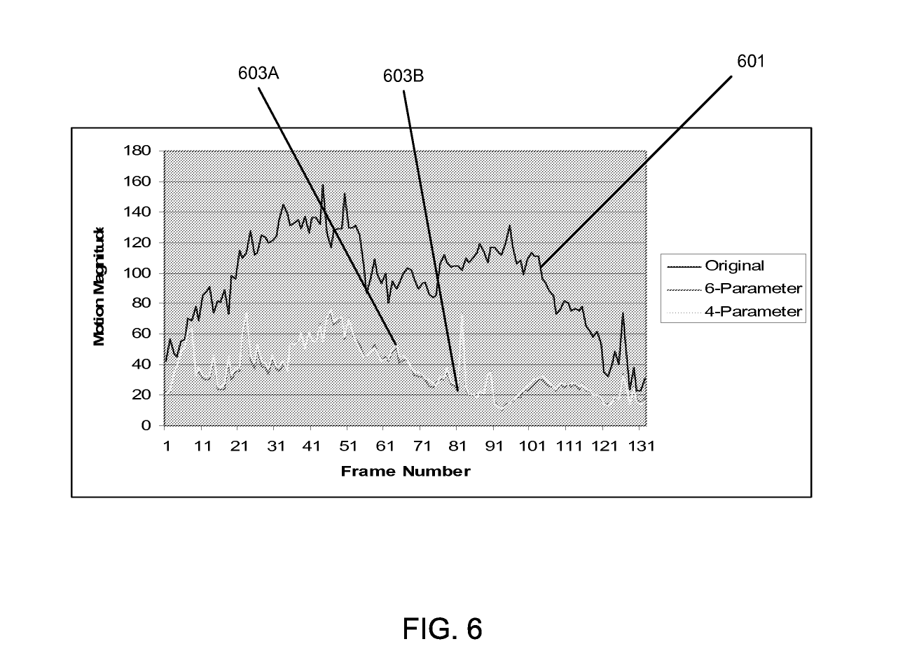

If the video segment is in an MPEG-2 format, for example, then for each P-frame in the video segment (and, where applicable, for each B-frame as well), at least some macroblocks in the frame will contain a motion vector and residual data reflecting a position of the macroblock relative to a corresponding image portion in an I-frame. If (dx, dy) represent the motion vector components of a block within such a macroblock, then the position determination module 303 may determine the magnitude of the position change of the block between frames to be |dx|+|dy|. Further, the position determination module 303 can determine the overall frame position change magnitude for an entire frame to be the average of each block position change magnitude |dx|+|dy| for each block in the frame. FIG. 5 illustrates a chart 501 (labelled “original” in the figure) showing the determined frame position change magnitude (labeled as “motion magnitude” in the figure and being measured in units of pixels) for each analyzed frame in a video segment. Similarly, FIG. 6 illustrates a chart 601 (labelled “original” in the figure) showing the determined frame position change magnitude (labeled as “motion magnitude” in the figure and being measured in units of pixels) for each analyzed frame in another video segment.

Once the position determination module 303 has determined a frame position change magnitude for each analyzed frame, in step 405 the position determination module 303 determines a representative position change magnitude A for the entire video segment. With various examples of the invention, the representative position change magnitude A may simply be the average of the frame position change magnitudes for each analyzed frame in the video segment. With still other implementations of the invention, however, more sophisticated statistical algorithms can be employed to determine a representative position change magnitude A. For example, some implementations of the invention may employ one or more statistical algorithms to discard or discount the position change magnitudes of frames that appear to be outlier values.

In step 407, the position determination module 303 determines if the representative position change magnitude A is below a threshold value. In the illustrated implementation of the invention, for example, the threshold value may be 10 pixels. If the position determination module 303 determines that the representative position change magnitude A is below the threshold value, then in step 409 the position determination module 303 categorizes the video segment as a stationary video segment.

### The Difference Determination Module

If, on the other hand, the position determination module 303 determines that the representative position change magnitude A is at or above the threshold value, then the difference determination module 305 will determine differences between corresponding image portions in each analyzed frame. More particularly, in step 411, the difference determination module 305 will determine a representative discrepancy value for the differences between image portions in each analyzed frame of the video segment and corresponding image portions in an adjacent analyzed frame. In this manner, the difference determination module 305 can ascertain whether the segment of video frames has captured a scene where either the camera or one or more objects are moving (i.e., where similar image portions appear from frame to frame), or a scene having content that changes over time (i.e., where the corresponding image portions are different from frame to frame).

With some implementations of the invention, the difference determination module 305 may employ affine modeling to determine a discrepancy value between image portions in the frames of the video segment. More particularly, the difference determination module 305 will try to fit an affine model to the motion vectors of the analyzed frames. As known in the art, affine modeling can be used to describe a relationship between two image portions. If two image portions are similar, then an affine model can accurately describe the relationship between the image portions with little or no residual values needed to describe further differences between the images. If, however, the images are significantly different, then the affine model will not provide an accurate description of the relationship between the images. Instead, a large residual value will be needed to correctly describe the differences between the images.

For example, if the video segment is in the MPEG-2 format, (x, y) can be defined as the block index of an 8×8 block of a macroblock. As previously noted, (dx, dy) will then be the components of the motion vector of the block. With various implementations of the invention, a 4-parameter affine model is used to relate the two quantities as follows:

$$[ \begin{matrix}a & b & c \\ - b & a & d\end{matrix} ] [ \begin{matrix}x \\ y \\ 1\end{matrix} ] = [ \begin{matrix}dx \\ dy\end{matrix} ] . \qquad ( 1 )$$

Typically, the 4-parameter model will provide sufficiently accurate determinations. It should be appreciated, however, that other implementations of invention may employ any desired parametric models, including 6-parameter and 8-parameter affine models.

Equation (1) can be rewritten as

$$[ \begin{matrix}x & y & 1 & 0 \\ y & - x & 0 & 1\end{matrix} ] [ \begin{matrix}a \\ b \\ c \\ d\end{matrix} ] = [ \begin{matrix}dx \\ dy\end{matrix} ] . \qquad ( 2 )$$

The affine parameters a, b, c, d can be solved using any desired technique. For example, with some implementations of the invention, the difference determination module 305 may solve the affine parameters a, b, c, d using the Iterative Weighted Least Square (IWLS) method, i.e. repetitively adjusting the weight matrix W in the following solution:

$${[ a b c d ]}^{T} = {( {X}^{T} WX )}^{- 1} {X}^{T} WD , \\ where \\ X = [ \begin{matrix}⋮ & ⋮ & ⋮ & ⋮ \\ {x}_{i} & {y}_{i} & 1 & 0 \\ {y}_{i} & - {x}_{i} & 0 & 1 \\ ⋮ & ⋮ & ⋮ & ⋮\end{matrix} ] , \\ D = [ \begin{matrix}⋮ \\ {dx}_{i} \\ {dy}_{i} \\ ⋮\end{matrix} ] , \\ W = [ \begin{matrix}⋰ & & & \\ & \frac{\frac{1}{{w}_{i}}}{{\sum }_{k = 0}^{N} \frac{1}{{w}_{k}}} & & \\ & & \frac{\frac{1}{{w}_{i}}}{{\sum }_{k = 0}^{N} \frac{1}{{w}_{k}}} & \\ & & & ⋰\end{matrix} ] , \\ i = 1 , 2 , … , N , \qquad ( 3 )$$

and N is the number of inter-coded blocks in the P-frame (or B-frame). At the first iteration, wᵢ is set to be the intensity residual (i.e., the direct current component) of the i^{th} inter-block encoded in the bitstream.

Afterwards, wᵢ is set to the L1 normalization of the parameter estimation residual of the previous iteration as follows:

wᵢ^{(t+1)}=|a^{(t)}xᵢ+b^{(t)}yᵢ+c^{(t)}−dxᵢ|+|a^{(t)}yᵢ−b^{(t)}xᵢ+d^{(t)}−dyᵢ|. (4)

In equation (4), the superscript (t) denotes the current iteration number. With various implementations of the tool 301, three iterations are performed. Of course, with still other examples of the analysis tool 301, fewer or more iterations may be performed depending upon the desired degree of accuracy for the affine model. It also should be appreciated that alternate embodiments of the invention may employ other normalization techniques, such as using the squares of the each of the values (a^{(t)}xᵢ+b^{(t)}yᵢ+c^{(t)}−dxᵢ) and (a^{(t)}yᵢ+b^{(t)}xᵢ+d^{(t)}−dyᵢ). Also, to avoid numerical problems, some embodiments of the invention may normalize all input data X and D by first shifting X so that the central block has the index [0, 0], and then scaling to within the range [−1, 1]. After equation (3) is solved, the coefficients a, b, c, d then are denormalized to the original location and scale.

If the analyzed frame contains complex content (that is, content that has significantly different images from frame to frame), then the affine model will not accurately describe the relationship between the index of the blocks in the analyzed frame and their motion vectors. Accordingly, the residual value of the frame determined in equation (4) will be approximately as large as the position change magnitude previously calculated for the frame. FIG. 5 illustrates a chart 503 showing an example of a residual for complex video content. As seen in this figure, the residual value (in units of pixels) for each analyzed frame closely corresponds to the motion vector magnitude of each analyzed frame. On the other hand, if the video content is not complex (i.e., if the motion in the analyzed frame is dominated by camera movement), then the affine model will more accurately describe the relationship between the index of the blocks in an analyzed frame and their motion vectors. In this instance, the residual value 603A of the frame determined in equation (4) will be much smaller than the position change magnitude 601 for the frame. An example of this type of video content is shown by chart 603 in FIG. 6. As seen in this figure, the residual value 603A produced using four-parameter affine modelling is substantially the same as the residual value 603B produced using six-parameter affine modelling

The difference determination module 305 may thus use the representative affine model residual value R for the frames in the video segment (calculated using equation (4) above) as a representative discrepancy value for the video segment. For example, the difference determination module 305 may determine the representative affine model residual value R for the frames to simply be the average of the residuals for each frame in the video segment. With still other implementations of the invention, however, more sophisticated statistical algorithms can be employed to determine a representative affine model residual value R. For example, some implementations of the invention may employ one or more statistical algorithms to discard or discount the residual values that appear to be outliers.

In any case, once the difference determination module 305 has determined a representative discrepancy for the video segment, in step 413 it then determines if the representative discrepancy is above a second threshold value. If the representative discrepancy is above this second threshold value, then in step 415 the difference determination module 305 categorizes the video segment as complex. For example, with the implementations of the analysis tool 301 described above, the difference determination module 305 uses the representative affine model residual value R as the representative discrepancy. If this representative affine model residual value R is larger than a threshold value, then the difference determination module 305 will categorize the video segment as a complex video segment in step 415. With various implementations of the analysis tool 301, for example the difference determination module 305 will categorize a video segment as complex if R>90% A

### The Motion Direction Change Identification Module

If the difference determination module 305 determines that the representative discrepancy is smaller than the second threshold value in step 413, then in step 417 the motion direction change identification module 307 will identify when the motion of an image portion changes in successive frames from a first direction to a second direction opposite the first direction. Then, in step 419, the motion direction change identification module 307 determines if the opposing direction changes occur at a representative frequency that is above a third threshold value. For example, with a video segment in the MPEG-2 format, the motion direction change identification module 307 will identify zero-crossings of the motion curves. Since (cᵢ,dᵢ) and (cᵢ₊₁,dᵢ₊₁) are proportional to the average motion vectors at analyzed frame i and analyzed frame i+1, respectively, a negative sign of their dot-product:

cᵢcᵢ₊₁+dᵢdᵢ₊₁

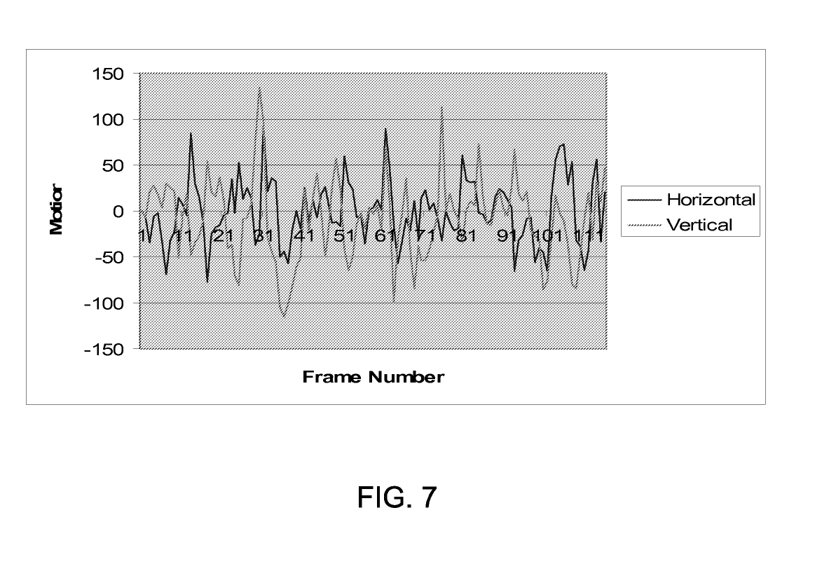

indicates a zero-crossing for both x-axis (e.g., up and down) and y-axis (e.g., left and right) directions. FIG. 7 illustrates the occurrences of zero-crossings for a video segment.

To avoid considering very small direction changes that will typically be irrelevant to the overall motion direction change of the video segment, a third threshold T may be used to eliminate very small direction changes. Thus, with various examples of the analysis tool 301, a zero-crossing of the motion curve may be defined as

cᵢcᵢ₊₁+dᵢdᵢ₊₁<T,

where i denotes the frame number. With various implementations of the analysis tool 301, for example, T=−50. Using the identified zero crossing above the designated threshold value T, the motion direction change identification module 307 then determines the frequency f_{z} of occurrences of the zero-crossings above the threshold value T in the video segment is calculated, as shown in FIG. 7.

If the zero crossing frequency f_{z} is higher than a designated value, then the motion direction change identification module 307 will categorize the video segment as shaky. For example, with some implementations of the analysis tool 301, the motion direction change identification module 307 will categorize the video segment as shaky if f_{z}<0.1. That is, if the zero-crossing higher than the threshold value T occur more than ten times in a video segment, then the motion direction change identification module 307 will categorize the video segment as shaky. Thus, in step 419, the motion direction change identification module 307 will determine the number of occurrence of zero-crossings Z of the motion curves in step 417. If the zero-crossings Z of the motion curves occur at a representative frequency f_{z} that is above a third threshold value, then in step 421 the motion direction change identification module 307 will categorize the video segment as shaky. If the motion direction change identification module 307 does not categorize the video segment as shaky in step 421, then in step 423 it categorizes the video segment as a moving video segment.

### CONCLUSION

As described above, various examples of the invention provide for categorizing video segments based upon the motion displayed in the video segments. As will be appreciated by those of ordinary skill in the art, this categorization of video segments can be useful in a variety of environments. Various implementations of the invention, for example, may be used to automatically edit video. Thus, an automatic video editing tool may use various embodiments of the invention to identify and then delete shaky video segments, identify and preserve moving and complex video segments, and/or identify and shorten stationary video segments, or even to identify video segments of a particular category or categories for manual editing. Further, various embodiments of the invention may be used, for example, to control the operation of a camera based upon the category of a video segment being used. Thus, a camera with automatic stabilization features may increase the effect of these features if video footage being filmed is categorized as shaky video footage. Of course, still other uses and benefits of various embodiments of the invention will be apparent to those of ordinary skill in the art.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while particular software and hardware modules and processes have been described as performing various functions, it should be appreciated that the functionality of one or more of these modules may be combined into a single hardware or software module. Also, while various features and characteristics of the invention have been described for different examples of the invention, it should be appreciated that any of the features and characteristics described above may be implemented in any combination or subcombination with various embodiments of the invention.

What is claimed is:

1. A method of categorizing a video segment, comprising:
analyzing a plurality of frames in a video segment to determine, for each analyzed frame, a position change of at least one image portion in the analyzed frame relative to a corresponding image portion in another frame;
if the determined position changes in the video segment have a representative magnitude below a first threshold value, categorizing the video segment as a stationary video segment;
if the representative magnitude of the determined position changes in the video segment is at or above the first threshold value, then, for each analyzed frame, determining differences between at least one second image portion in the analyzed frame relative to at least one second corresponding image portion in another frame;
if the determined differences have a representative discrepancy above a second threshold value, categorizing the video segment as a complex video segment;
if the representative discrepancy of the determined differences is at or below the second threshold value, identifying motion changes of corresponding third image portions in the frames of the video segment in substantially opposite directions;
if the identified motion direction changes occur at a representative frequency above a third threshold value, categorizing the video segment as a shaky video segment; and
if the identified position direction changes occur at a representative frequency at or below a third threshold value, then categorizing the video segment as a moving video segment.

2. The method recited in claim 1, wherein
the video segment is encoded using a compressed digital format; and
further comprising, for each frame, using a motion vector of the at least one image portion in the frame to determining the position change of the at least one image portion in the frame relative to the corresponding image portion in another frame.

3. The method recited in claim 2, wherein
the motion vector has components dx and dy; and
further comprising determining a magnitude of determined position changes for each frame to be |dx|+|dy|.

4. The method recited in claim 3, wherein the representative magnitude of the determined position changes in the video segment is an average of the magnitude of determined position changes for each frame in the video segment

5. The method recited in claim 2, wherein
the compressed data format is the MPEG-2 or MPEG-4 format, and
the at least one first image portion is a block.

6. The method recited in claim 1, wherein
the video segment is encoded using a compressed digital format; and
further comprising using affine modeling to determine the differences between the at least one second image portion in the frame relative to the at least one second corresponding image portion in another frame.

7. The method recited in claim 6, further comprising obtaining the representative discrepancy of the determined differences from a residual of the affine modeling.

8. The method recited in claim 7, wherein the second threshold is ninety percent of the representative magnitude of the determined position changes in the video segment.

9. The method recited in claim 6, wherein the affine modeling employs a four parameter affine model.

10. The method recited in claim 6, wherein
the compressed data format is the MPEG-2 or MPEG-4 format; and
the at least one first image portion is a block.

11. The method recited in claim 6, further comprising identifying motion direction changes in substantially opposite directions based upon parameters employed in the affine modeling.

12. A video segment analysis tool, comprising:
a position determination module configured to
determine, for frames in a video segment, a position change of at least one first image portion in a frame relative to a first corresponding image portion in another frame, and
if the determined position changes in the video segment have a representative magnitude below a first threshold value, categorize the video segment as a stationary video segment;
a difference determination module configured to
determine, for frame in the video segment, differences between at least one second image portion in the frame relative to at least one second corresponding image portion in another frame; and
if the representative magnitude of the determined position changes in the video segment is at or above the first threshold value and if the determined differences have a representative discrepancy above a second threshold value, categorize the video segment as a complex video segment; and
a motion direction change identification module configured to identify motion changes of corresponding third image portions in the frames of the video segment in substantially opposite directions, and
if the representative magnitude of the determined position changes in the video segment is at or above the first threshold value, if the determined differences have a representative discrepancy at or below the second threshold value, and if the identified motion direction changes have a representative frequency above a third threshold value, categorize the video segment as a shaky video segment; and
if the representative magnitude of the determined position changes in the video segment is at or above the first threshold value, if the determined differences have a representative discrepancy at or below the second threshold value, and if the identified position direction changes occur at a representative frequency at or below a third threshold value, categorize the video segment as a moving video segment.

13. The video segment analysis tool recited in claim 12, wherein
the video segment is encoded using a compressed digital format; and
the position determination module is configured to use a motion vector of the at least one image portion in the frame to determine the position change of the at least one image portion in the frame relative to the corresponding image portion in another frame.

14. The video segment analysis tool recited in claim 13, wherein
the motion vector has components dx and dy; and
the position determination module is configured to determine a magnitude of determined position changes for each frame to be |dx|+|dy|.

15. The video segment analysis tool recited in claim 14, wherein the position determination module configured to determine the representative magnitude of the determined position changes in the video segment to be an average of the magnitude of determined position changes for each frame in the video segment

16. The video segment analysis tool recited in claim 13, wherein
the compressed data format is the MPEG-2 or MPEG-4 format, and
the at least one first image portion is a block.

17. The video segment analysis tool recited in claim 12, wherein
the video segment is encoded using a compressed digital format; and
the difference determination module is configured to use affine modeling to determine the differences between the at least one second image portion in the frame relative to the at least one second corresponding image portion in another frame.

18. The video segment analysis tool recited in claim 17, wherein the difference determination module is configured to obtain the representative discrepancy of the determined differences from a residual of the affine modeling.

19. The video segment analysis tool recited in claim 18, wherein the second threshold is ninety percent of the representative magnitude of the determined position changes in the video segment.

20. The video segment analysis tool recited in claim 17, wherein the difference determination module is configured to employ a four parameter affine model for the affine modeling.

21. The video segment analysis tool recited in claim 17, wherein
the compressed data format is the MPEG-2 or MPEG-4 format; and
the at least one first image portion is a block.

22. The video segment analysis tool recited in claim 17, wherein the motion direction change identification module is configured to identify motion direction changes in substantially opposite directions based upon parameters employed in the affine modeling
